(19) United States
(12) Patent Application Publication
(10) Pub. No.: US 2010/0079370 A1
(43) Pub. Date: Apr. 1, 2010

(54) Apparatus and method for providing interactive user interface that varies according to strength of blowing

(75) Inventors: Kwan-Sic Kim, Yongin-si (KR); Kyung-Taek Kwon, Seoul (KR); Jin-Choul Lee, Suwon-si (KR)

Correspondence Address: DOCKET CLERK, P.O. DRAWER 800889, DALLAS, TX, 75380, US

(73) Assignee: Samsung Electronics Co., Ltd., Suwon-si (KR)

(21) Appl. No.: 12/586,840

(22) Filed: Sep. 29, 2009

(30) Foreign Application Priority Data
Sep. 30, 2008 (KR) 10-2008-0096113

(51) Int. Cl. G09G 5/00

(52) U.S. Cl. 345/156

(57) ABSTRACT

An apparatus includes an interactive user interface that varies according to strength of blowing. A sensor detects blowing from a user and outputs a strength value of the detected blowing. A memory stores interactive image data capable of giving an effect of responding to user's blowing strength in real time. A controller loads interactive image data corresponding to the strength value of the blowing from the memory, and configures an interactive image that varies according to the strength value of the blowing, using the loaded interactive image data. A display displays the configured interactive image under control of the controller.

### CROSS-REFERENCE TO RELATED APPLICATION(S) AND CLAIM OF PRIORITY

The present application is related to and claims the benefit under 35 U.S.C. §119(a) of a Korean Patent Application filed in the Korean Intellectual Property Office on Sep. 30, 2008 and assigned Serial No. 10-2008-0096113, the entire disclosure of which is hereby incorporated by reference.

### TECHNICAL FIELD OF THE INVENTION

The present invention relates generally to an apparatus and method for providing a user interface, and more particularly, to an apparatus and method for providing an interactive user interface that varies according to strength of blowing or puffing.

### BACKGROUND OF THE INVENTION

Recently, mobile communication terminals have adopted various additional functions to improve convenience and efficiency. As an example of such additional functions, a screen of a mobile communication terminal is used not only to indicate a status of the mobile communication terminal or display a variety of information, but also to display enjoyable images for the user at normal times or display execution of games.

Keys, a touch screen, and the like, which are input devices of the mobile communication terminal, are used as interfaces that enable interactions. Conventionally, however, images and videos are displayed simply on the screen, and displaying on the screen does not change by active participation of the user. With the increasing popularization of multimedia contents, development of various dynamic multimedia applications that can be installed in mobile communication terminals and in which users can participate is now possible. The current input scheme in the mobile communication terminals has many limitations in providing such additional functions. For example, the user may enjoy games or select menus only through the simple and repetitive key manipulations.

Conventionally, a method for implementing interactions with users in a user interface of the mobile communication terminal has not been seriously considered. Accordingly, the user enjoys functions of the mobile communication terminal by using only the simple input method such as key manipulation. However, there is a need to meet the demands for new amusing interfaces enabling users to enjoy various dynamic multimedia applications installed in the mobile communication terminals, thereby improving user convenience.

### SUMMARY OF THE INVENTION

To address the above-discussed deficiencies of the prior art, it is a primary object to provide at least the advantages described below. Accordingly, an aspect of the present invention provides an apparatus and method for providing an interactive user interface to offer a user a new enjoyable interface.

Another aspect of the present invention provides an apparatus and method for providing an interactive user interface to implement interaction with a user.

According to one aspect of the present invention, there is provided an apparatus for providing an interactive user interface that varies according to strength of blowing. The apparatus includes a sensor for detecting blowing from a user and outputting a strength value of the detected blowing; a memory for storing interactive image data capable of giving an effect of responding to user's blowing strength in real time; a controller for loading interactive image data corresponding to the strength value of the blowing from the memory, and configuring an interactive image that varies according to the strength value of the blowing, using the loaded interactive image data; and a display for displaying the configured interactive image under control of the controller.

According to another aspect of the present invention, there is provided a method for providing an interactive user interface that varies according to strength of blowing. The method includes detecting blowing from a user; configuring an interactive image that varies in response to the detected blowing; and displaying the configured interactive image.

According to a further aspect of the present invention, there is provided a method for providing an interactive user interface that varies according to strength of blowing. The method includes displaying an indicator configured to indicate at least one of a plurality of user data items; upon detecting blowing from a user, measuring a strength of the detected blowing; and shifting and displaying the indicator according to the measured strength of the blowing.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an internal structure of a mobile communication terminal offering an interactive user interface according to an embodiment of the present invention;

FIG. 2 illustrates a method for implementing a variation of an image depending on a blowing strength according to an embodiment of the present invention;

FIGS. 3A and 3B illustrate blowing-based candlelight screens according to an embodiment of the present invention;

FIGS. 4A and 4B illustrate blowing-based petal blowing screens according to an embodiment of the present invention;

FIG. 5 illustrates a blowing-based game screen according to an embodiment of the present invention;

FIG. 6 illustrates a blowing-based text message transfer screen according to an embodiment of the present invention;

FIG. 7 illustrates blowing-based shifting among menu items according to an embodiment of the present invention;

FIGS. 8A and 8B illustrate a blowing-based zoom function according to an embodiment of the present invention; and

FIG. 9 illustrates a blowing-based hot key function according to an embodiment of the present invention.

### DETAILED DESCRIPTION OF THE INVENTION

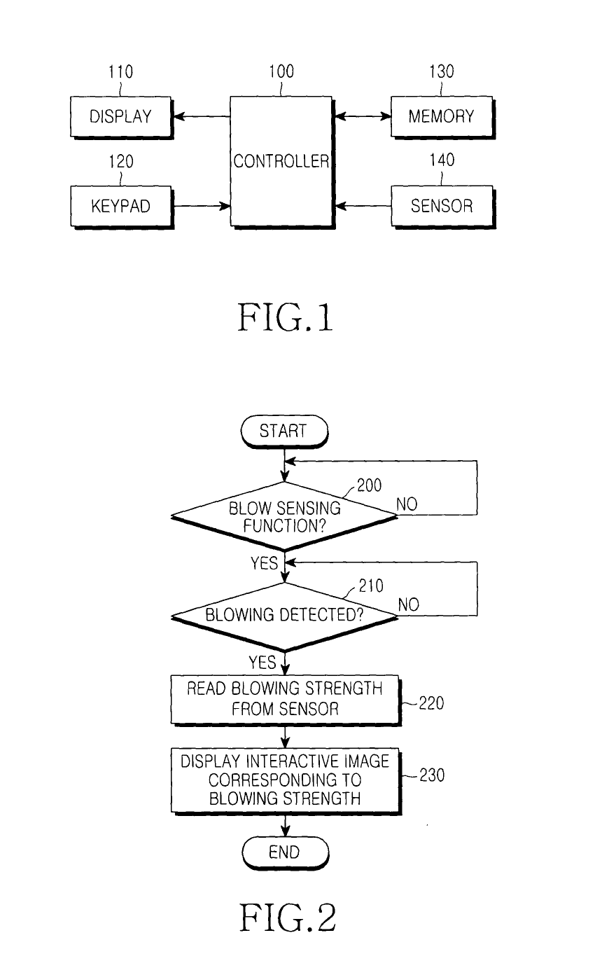

FIGS. 1 through 9, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged mobile electronic device. Embodiments of the present invention are described in detail with reference to the accompanying drawings. The same or similar components may be designated by the same or similar reference numerals although they are illustrated in different drawings. Detailed descriptions of constructions or processes known in the art may be omitted to avoid obscuring the subject matter of the present invention. Detailed descriptions of constructions or processes known in the art may be omitted to avoid obscuring the subject matter of the present invention.

The present invention provides a method for offering an interactive user interface, for which a sensor capable of sensing blowing from a user is mounted on a mobile communication terminal in order to implement interaction with the user. Such a sensor-mounted mobile communication terminal can receive a user's blowing strength from the sensor and output an interactive image that changes according to the received blowing strength. Thus, the user may see an interactive image responding to his blowing, feeling as if he is controlling the image by himself.

Operation and components of the mobile communication terminal with the function described above will be described with reference to FIG. 1.

FIG. 1 illustrates an internal structure of a mobile communication terminal offering an interactive user interface according to an embodiment of the present invention.

Referring to FIG. 1, the mobile communication terminal roughly includes a controller 100, a display 110, a keypad 120, a memory 130 and a sensor 140.

The display 110, which may include a display device such as Liquid Crystal Display (LCD), displays an interactive image that varies step by step based on a strength of blowing, under the control of the controller 100 in accordance with an embodiment of the present invention.

The keypad 120 is connected to the controller 100 and includes a plurality of alphanumeric keys. The keypad 120 can provide the controller 100 with control signals from the user regarding shift and selection of user data items, as well as control commands based on strength of user's blowing sensed by the sensor 140.

The memory 130 includes a Read Only Memory (ROM) and a Random Access Memory (RAM) for storing various dynamic multimedia applications and permanent/temporary data. The memory 130 stores interactive image data that can give an effect of responding to a user's blowing strength in real time according to an embodiment of the present invention. In particular, the memory 130 stores a three-dimensional (3D) engine to implement a Graphic User Interface (GUI) in a more vivid way that responds to strength of blowing.

The sensor 140 is attached to the exterior of the mobile communication terminal and detects a user's blowing that comes in through an inlet in the sensor's location. The sensor 140 can be a wind speed sensor that outputs an electric signal corresponding to strength of the user's blowing, and the wind speed sensor can provide the controller 100 with its output value that rises with the strength of the user's blowing. Alternatively, the sensor 140 can be a temperature sensor or a humidity sensor that can sense breath blowing of the user, and theses sensors also can provide the controller 100 with an output value that includes a different level according to the blowing strength.

According to an embodiment of the present invention, the strength of blowing can be used to implement an interactive image. However, in an alternative embodiment of the present invention, the strength of blowing may be used as a control signal from the user regarding shift and selection of user data items, similar to a control signal from the keypad 120. For example, if blowing from the user is detected while an indicator indicating any one of a plurality of user data items is displayed on the display 110, the controller 100 can shift and display the indicator according to strength of the blowing.

In accordance with an embodiment of the present invention, the controller 100, which carries out the overall control operation of the mobile communication terminal, loads interactive image data corresponding to the blowing strength from the memory 130. The controller 100 configures an interactive image that changes according to the user's blowing strength using the loaded interactive image data. Thereafter, the controller 100 displays the interactive image configured based on the blowing strength, on the display 110. More specifically, upon receipt of a user's blowing strength level from the sensor 140, the controller 100 calculates contents of an interactive screen to be displayed on the display 110 in response to the blowing strength level and continuously updates and displays the screen.

When the blowing strength is used in place of the keypad 120 in accordance with the alternative embodiment of the present invention, the controller 100 outputs a control signal for controlling an operation of the mobile communication terminal according to the blowing strength. That is, when the blowing strength is used as a control signal, the controller 100 can determine key input data to which the blowing strength's level corresponds, and performs an operation corresponding to the determination result.

A control flow for implementing a mechanism of varying an interactive image according to a blowing strength in the mobile communication terminal will now be described with reference to FIG. 2.

FIG. 2 illustrates a method for implementing a variation of an image depending on a blowing strength according to an embodiment of the present invention.

Referring to FIG. 2, the controller 100 determines in step 200 whether or not a blow sensing function is set. The term ‘blow sensing function’ as used herein refers to a function of controlling an operation of a mobile communication terminal according to strength of blowing from a user. If the blow sensing function is set in step 200, the controller 100 determines in step 210 whether blowing is detected by the sensor 140. If blowing is detected, the controller 100 reads a strength value of the blowing from the sensor 140 in step 220. That is, the blowing measurement in the sensor 140 can be accomplished under the control of the controller 100. In step 230, the controller 100 configures an interactive image corresponding to the measured blowing strength value and displays the interactive image on the display 110.

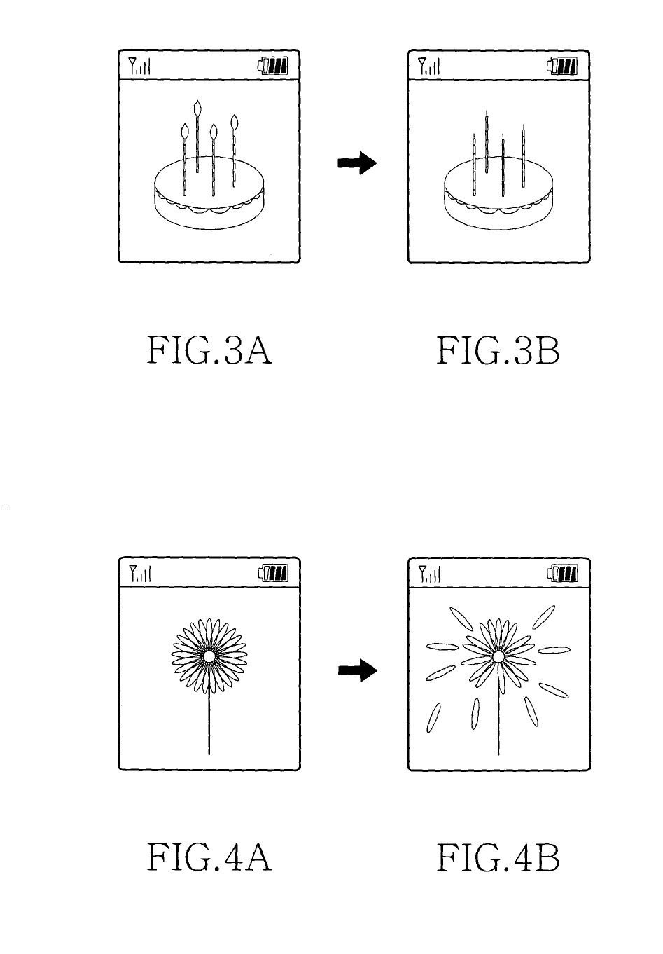

Reference will now be made to FIGS. 3A through 9 to describe in detail various examples to which the present invention is applicable. While embodiments of the present invention will be described with reference to FIGS. 3A to 9, the method of displaying an interactive image or controlling an operation of the mobile communication terminal based on blowing is not limited to the embodiments of the present invention described below.

FIGS. 3A and 3B illustrate blowing-based candlelight screens according to an embodiment of the present invention. For example, if the user blows at an image of candles with flame on, which is displayed on the screen, then an image of candles with flame off is displayed in response to the blowing as if the flame of candles has actually been blown out. Here, the number of candles with flame off can be determined based on a strength value of the blowing. In this manner, the user may have an experience of controlling a virtual candlelight image on the screen as though she blows out actual candles.

FIGS. 4A and 4B illustrate blowing-based petal blowing screens according to an embodiment of the present invention, in which the user blows off petals. Here, an interactive image is displayed in which when the user blows at the image, petals are blown away in response to the blowing.

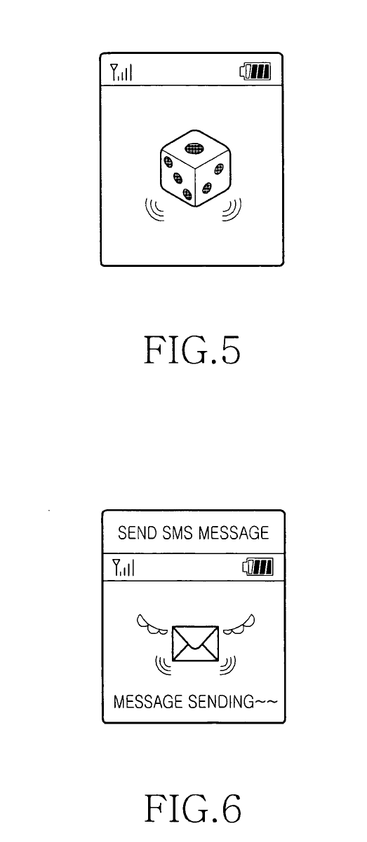

Aside from the foregoing, a function may be provided in which the user can enjoy games vividly without key manipulation as shown in FIG. 5. An example may include a game of rolling a dice by blowing. As a different interactive image is displayed according to the user's blowing strength, such a game may be joyfully enjoyed between friends or couples. That is, the user can vividly enjoy the game on the mobile communication terminal that she always carries, as if she actually plays dice. Similarly, the screen output is determined according to how strongly the user blows at the screen.

FIG. 6 illustrates a blowing-based text message transfer screen according to an embodiment of the present invention. Here, when the user blows at the screen instead of pushing a Send button after writing a text message, an image is displayed as if the message flies away.

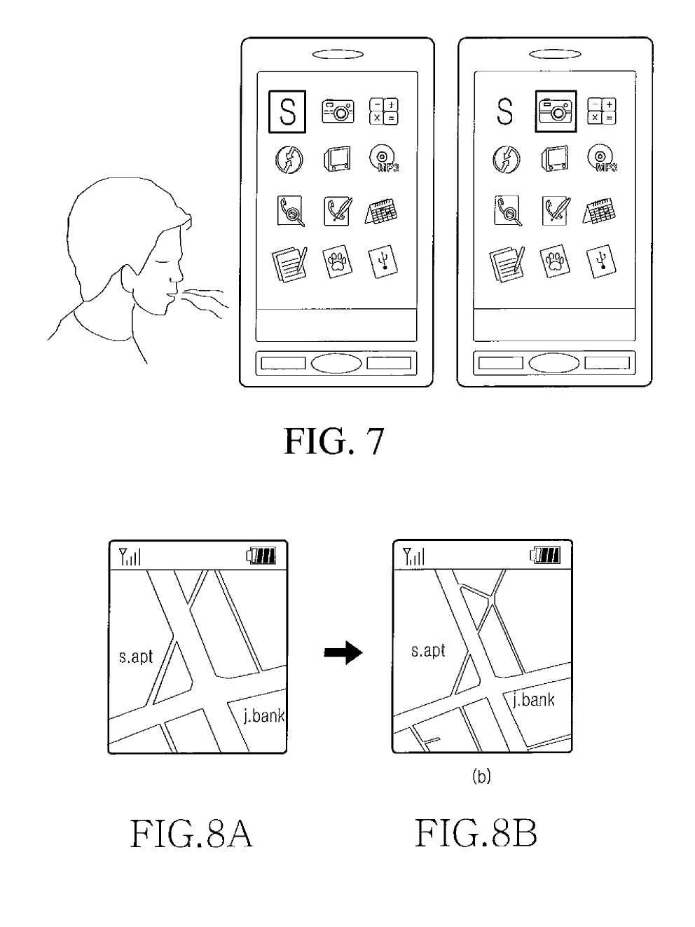

While it has been described that interactive images are displayed that respond to the blowing, the user's blowing may be used as an interface enabling interactions with the user, which replaces the keypad 120 that is an input device of the mobile communication terminal. As an example, FIG. 7 illustrates blowing-based shifting among menu items according to an embodiment of the present invention. An indicator indicating shifting among menu items can move fast or slow according to strength of the blowing. Similarly, shifting among user data items may also be accomplished by user's blowing.

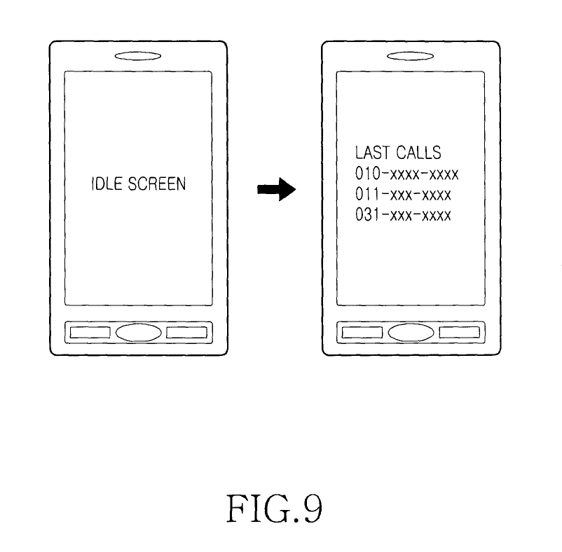

FIGS. 8A and 8B illustrate a blowing-based zoom function according to an embodiment of the present invention, in which user's blowing can be used for zooming-in/out. FIG. 9 illustrates a blowing-based hot key function according to an embodiment of the present invention, in which user's blowing can be used for performing a hot key function such as a call connection key. In this way, the user's blowing can be used in place of the keypad 120, and may be applied to various other applications as well.

Accordingly, if the user just blows at the screen (for example, at the sensor) of the mobile communication terminal, an image displayed on the screen can change according to strength of the blowing. Thus, the user may experience a dynamic variation of the image without button manipulation.

As is apparent from the foregoing description, by offering a user interface that varies according to user's blowing strength, it is possible to add entertainment features to the user interface of the mobile communication terminal. In addition, the user can freely set and change the user interface through physical interaction, contributing to growth of the industry related to providing various dynamic multimedia applications.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. An apparatus capable of providing an interactive user interface that varies according to strength of blowing, the apparatus comprising:
a sensor configured to detect blowing from a user and outputting a strength value of the detected blowing;
a memory configured to store interactive image data capable of giving an effect of responding to user's blowing strength in real time;
a controller configured to load interactive image data corresponding to the strength value of the blowing from the memory, and capable of configuring an interactive image that varies according to the strength value of the blowing, using the loaded interactive image data; and
a display configured to display the configured interactive image under control of the controller.

2. The apparatus of claim 1, wherein the sensor is at least one of a wind speed sensor and a humidity sensor.

3. The apparatus of claim 1, wherein upon receiving the strength value of the blowing from the sensor, the controller shifts an indicator that indicates a user data item according to the strength value of the blowing and displays the indicator on the display.

4. The apparatus of claim 1, wherein the sensor delivers the strength value of the blowing to the controller as a control signal for controlling an operation of the apparatus.

5. The apparatus of claim 4, wherein the operation of the apparatus comprises at least one of: a shift function; a zoom function; a text function and a game function.

6. The apparatus of claim 1, wherein the apparatus comprises a mobile communications terminal.

7. The apparatus of claim 1, further comprising a keypad, wherein the sensor is capable of replacing the keypad.

8. A method for providing an interactive user interface that varies according to strength of blowing, the method comprising:
detecting blowing from a user;
configuring an interactive image that varies in response to the detected blowing; and
displaying the configured interactive image.

9. The method of claim 8, wherein the detecting of blowing comprises measuring a strength value of the detected blowing.

10. The method of claim 9, wherein the configuring of an interactive image comprises configuring an interactive image that varies step by step according to strength of blowing, in response to the measured strength value of the blowing.

11. The method of claim 8, wherein the displaying of the configured interactive image comprises displaying an image of candles with flame off in response to the blowing.

12. The method of claim 8, further comprising controlling an operation of a device based on the detected blowing.

13. The method of claim 12, wherein the operation comprises one of: a shift function; a zoom function; a text function and a game function.

14. A method for providing an interactive user interface that varies according to strength of blowing, the method comprising:
displaying an indicator indicating at least one of a plurality of user data items;
upon detecting blowing from a user, measuring a strength of the detected blowing; and
shifting and displaying the indicator according to the measured strength of the blowing.

15. A mobile terminal capable of running a plurality of applications, the mobile terminal comprising:
an interactive user interface that varies according to strength of blowing, the interactive user interface comprising:
a sensor configured to detect blowing from a user and outputting a strength value of the detected blowing;
a memory configured to store interactive image data capable of giving an effect of responding to user's blowing strength in real time; and
a controller configured to load interactive image data corresponding to the strength value of the blowing from the memory, and capable of configuring an interactive image that varies according to the strength value of the blowing, using the loaded interactive image data; and
a display configured to display the configured interactive image under control of the controller.

16. The terminal of claim 15, wherein the sensor is at least one of a wind speed sensor and a humidity sensor.

17. The terminal of claim 15, wherein upon receiving the strength value of the blowing from the sensor, the controller shifts an indicator that indicates a user data item according to the strength value of the blowing and displays the indicator on the display.

18. The terminal of claim 15, wherein the sensor delivers the strength value of the blowing to the controller as a control signal for controlling an operation of the apparatus.

19. The terminal of claim 18, wherein the operation of the apparatus comprises at least one of: a shift function; a zoom function; a text function and a game function.

20. The terminal of claim 15, further comprising a keypad, wherein the sensor is capable of replacing the keypad.
